(19) United States
(12) Patent Application Publication
(10) Pub. No.: US 2025/0377918 A1
(43) Pub. Date: Dec. 11, 2025

(54) SYSTEMS AND METHODS FOR OPTIMIZED HELP CENTER PORTAL

(71) Applicant: Royal Bank of Canada, Toronto (CA)

(72) Inventors: Jaymil CHAUDHARI, Burlington (CA); Yuxin WANG, Toronto (CA); Maaz SIDDIQI, Toronto (CA); Rache CHEN, Toronto (CA)

(73) Assignee: Royal Bank of Canada, Toronto (CA)

(21) Appl. No.: 19/294,853

(22) Filed: Aug. 8, 2025

Related U.S. Application Data
(60) Provisional application No. 63/685,447, filed on Aug. 21, 2024.

(51) Int. Cl. G06F 9/451; G06F 21/31; G06Q 30/016

(52) U.S. Cl. CPC G06F 9/453; G06F 21/31; G06Q 30/016

(57) ABSTRACT

Systems and methods of implementing help center platform interactions are described relating to a web-based call portal platform that streamlines calls to help centers by providing on-call pre-authorization, redirection to self-serve resources, and AI-enhanced interaction generation and summaries.

### CROSS-REFERENCE TO PREVIOUS APPLICATION

This application claims priority from U.S. provisional patent application 63/685,447 filed on Aug. 21, 2024, which is incorporated herein by reference in its entirety.

### FIELD

The present disclosure generally relates to the field of help center software. In particular, various embodiments are described herein that generally relate to systems and methods for streamlining and optimizing help center interactions via a web-based AI-enhanced portal.

### INTRODUCTION

The following paragraphs are provided by way of background to the present disclosure. They are not, however, an admission that anything discussed therein is prior art or part of the knowledge of persons skilled in the art.

Help centers are typically centralized platforms that provide assistance, support, and information to users (i.e., employees, customers or members of the public). Such platforms often include Frequently Asked Questions (FAQ) sections, guides, web-based content, chatbots, and other self-service resources to help users find answers to their questions or resolve issues independently. Access points to help centers are commonly found on websites or within software applications and are designed to improve user experience by offering easy access to relevant self-service information and, in some cases, access to live agents via live-chat or connection to a telephone call center. Agents in call centers can assist customers with inquiries, resolve issues, process orders, and provide technical support. They often use software tools to manage calls, track customer interactions, and access information quickly.

Known help center platforms typically use a sequential combination of self-service portal decision trees, followed by call routing. A self-service portal decision tree is an organized, branching model that guides users through a series of questions and decisions to help them find solutions to their issues. The aim of a self-service portal is to allow a user to arrive at the information they are seeking, without the need to engage a live agent during the process. In some cases, self-service portals fail to provide a user with the information they are seeking. In such cases, the user may be asked by the system to engage a live agent by initiating a live-chat or calling a telephone call center. One of the technical difficulties with telephone call centers is that, to ensure an efficient use of resources, users are often asked to join a call queue and wait for several minutes before being connected to a live agent.

Such wait times can lead to a user feeling frustrated and impatient, as they can feel like their time is being wasted. Then, once the user is eventually connected to a live agent, the user is required to identify and authenticate themselves, and to explain the nature of their enquiry to the live agent, before eventually receiving help. These further steps often add to the user's feelings of frustration and impatience.

There is a clear need for systems and methods for streamlining and optimizing help center interactions that addresses the challenges and shortcomings described above.

### SUMMARY

Various embodiments of systems and methods for streamlining and optimizing help center interactions are provided according to the teachings herein.

According to an aspect of the present disclosure, there is disclosed a method of implementing help center platform interactions. The method comprises receiving a user enquiry via a user interaction portal and providing the user with contact information of a live agent help center and a ticket number associated with the enquiry and an interaction session via the user interaction portal. The method also comprises, while the user is waiting in a queue to be connected to a live agent, initiating an interaction. The interaction session is initiated by prompting a question engine using the enquiry and an interaction history generated during the session, the output of the question engine being at least one question related to the enquiry and displaying the at least one question to the user via the user interaction portal. The interaction session is also initiated by obtaining at least one answer to the at least one question from the user via the user interaction portal, adding the at least one question and any associated at least one answer to the interaction history related to the session, and repeating the above steps of prompting a question engine, displaying at least one question, obtaining at least one answer and adding the at least one question and at least one answer to the interaction history until detection of an end trigger event.

In some examples, the method further comprises determining whether the enquiry can be attributed to a self-service resource and, if the enquiry can be attributed to a self-service resource, providing the user with access to the self-service resource via the user interaction portal and, if the enquiry cannot be attributed to a self-service resource, proceeding to initiating an interaction session.

In some examples, the self-service resource is one or more of a specialized chatbot, web pages, knowledge bases, FAQs, troubleshooting guides, telephone numbers or webpages of individuals or departments, and/or forums and tutorials.

In some examples, determining whether the enquiry can be attributed to a self-service resource is performed by the question engine.

In some examples, the method further comprises: if the end trigger event is detected, summarizing the enquiry and the interaction history generated during the session to produce an interaction summary including the ticket number.

In some examples, the interaction summary is used to populate an interaction build in a service delivery platform.

In some examples, the interaction summary and/or the interaction build is forwarded to a live agent assigned to the ticket number.

In some examples, the step of initiating an interaction session further comprises waiting until the user uses the contact information to contact the live agent help center before prompting the question engine.

In some examples, the contact information corresponds to a telephone number associated with the live agent help center and the live agent help center is a telephone call center.

In some examples, the contact information corresponds to a chat button associated with the live agent help center and the live agent help center is a chat center.

In some examples, the telephone number is also associated with the ticket number.

In some examples, the user interaction portal is a web-portal requiring user authentication.

In some examples, the question engine is implemented using a Large Language Model.

In some examples, the question engine is implemented using Retrieval-Augmented Generation.

According to another aspect of the present disclosure, there is disclosed a non-transitory computer program product comprising computer-implemented instructions to cause a computer system to execute the above method.

According to yet another aspect of the present disclosure, there is disclosed a computer system comprising one or more computer processors and one or more computer readable storage media for storing computer-implemented instructions, wherein the one or more computer processors are configured to execute the computer-implemented instructions to cause the computer system to implement the above method.

Other features and advantages of the present disclosure will become apparent from the following detailed description taken together with the accompanying drawings. It should be understood, however, that the detailed description and the specific examples, while indicating preferred embodiments of the application, are given by way of illustration only, since various changes and modifications within the spirit and scope of the application will become apparent to those skilled in the art from this detailed description.

### DRAWINGS

For a better understanding of the various embodiments described herein, and to show more clearly how these various embodiments may be carried into effect, reference will be made, by way of example, to the accompanying drawings which show at least one example embodiment, and which are now described. The drawings are not intended to limit the scope of the teachings described herein. In the drawings:

FIG. 1 shows a computer network suitable for implementing embodiments in accordance with systems and methods of the present disclosure;

FIG. 2 shows a server comprising part of the system shown in FIG. 1;

FIG. 3 is a high-level block diagram of embodiments in accordance with systems of the present disclosure;

FIG. 4 is flowchart representing embodiments in accordance with methods of the present disclosure; and

FIG. 5 is another flowchart representing embodiments in accordance with methods of the present disclosure.

Further aspects and features of the example embodiments described herein will appear from the following description taken together with the accompanying drawings.

### DESCRIPTION OF VARIOUS EMBODIMENTS

Various embodiments in accordance with the teachings herein will be described below to provide an example of at least one embodiment of the claimed subject matter. No embodiment described herein limits any claimed subject matter. The claimed subject matter is not limited to devices, systems, or methods having all the features of any one of the devices, systems, or methods described below or to features common to multiple or all of the devices, systems, or methods described herein. It is possible that there may be a device, system, or method described herein that is not an embodiment of any claimed subject matter. Any subject matter that is described herein that is not claimed in this document may be the subject matter of another protective instrument, for example, a continuing patent application, and the applicants, inventors, or owners do not intend to abandon, disclaim, or dedicate to the public any such subject matter by its disclosure in this document.

It will be appreciated that for simplicity and clarity of illustration, where considered appropriate, reference numerals may be repeated among the figures to indicate corresponding or analogous elements. In addition, numerous specific details are set forth to provide a thorough understanding of the embodiments described herein. However, it will be understood by those of ordinary skill in the art that the embodiments described herein may be practiced without these specific details. In other instances, well-known methods, procedures, and components have not been described in detail so as not to obscure the embodiments described herein. Also, the description is not to be considered as limiting the scope of the embodiments described herein.

Some elements herein may be identified by a part number, which is composed of a base number followed by an alphabetical or numerical suffix (e.g., 184A, or 184₁). Multiple elements herein may be identified by part numbers that share a base number in common and that differ by their suffixes (e.g., 184₁, 184₂, and 184₃). All elements with a common base number may be referred to collectively or generically using the base number without a suffix (e.g., 184).

The example embodiments of the devices, systems, or methods described in accordance with the teachings herein may be implemented as a combination of hardware and software. For example, the embodiments described herein may be implemented, at least in part, by using one or more computer programs, executing on one or more programmable devices comprising at least one processing element and at least one storage element (i.e., at least one volatile memory element and at least one non-volatile memory element). The hardware may comprise input devices including one or more of a touch screen, a keyboard, a mouse, buttons, keys, sliders, and the like, as well as one or more of a display, a printer, and the like depending on the implementation of the hardware.

It should also be noted that there may be some elements that are used to implement at least part of the embodiments described herein that may be implemented via software that is written in a high-level programming language. The program code may be written in Rust, C++, C #, JavaScript, Python, or any other suitable programming language and may comprise modules or classes, as is known to those skilled in the art. Alternatively, or in addition thereto, some of these elements implemented via software may be written in assembly language, machine language, or firmware as needed. In either case, the language may be a compiled or interpreted language.

At least some of these software programs may be stored on a computer readable medium such as, but not limited to, a ROM, a magnetic disk, an optical disc, solid-state storage, a USB key, and the like that is readable by a device having a processor, an operating system, and the associated hardware and software that is necessary to implement the functionality of at least one of the embodiments described herein. The software program code, when read by the device, configures the device to operate in a new, specific, and predefined manner (e.g., as a specific-purpose computer) in order to perform at least one of the methods described herein.

At least some of the programs associated with the devices, systems, and methods of the embodiments described herein may be capable of being distributed in a computer program product comprising a computer readable medium that bears computer usable instructions, such as program code, for one or more processing units. The medium may be provided in various forms, including non-transitory forms such as, but not limited to, one or more diskettes, compact disks, tapes, chips, and magnetic and electronic storage. In alternative embodiments, the medium may be transitory in nature such as, but not limited to, wire-line transmissions, satellite transmissions, internet transmissions (e.g., downloads), media, digital and analog signals, and the like. The computer useable instructions may also be in various formats, including compiled and non-compiled code.

As used herein, the term “RAG” or “Retrieval-Augmented Generation” means any framework that integrates a retriever and a generator. The retriever identifies relevant documents or passages from a large dataset based on a query, while the generator uses this information to generate coherent and contextually relevant text. This approach is effective for customer support, as it combines the precision of retrieval with the fluency of generative models, resulting in more accurate and informative responses.

In accordance with the teachings herein, there are provided various embodiments for systems and methods related to a web-based call portal platform that streamlines calls to the help centers by provide on-call pre-authorization, redirection to self-serve resources, and AI-enhanced interaction generation and summaries. In some embodiments, the platform is available to employees of large organizations, such as corporations or financial institutions, to assist the employees of such organizations in accessing human resources (HR) information, advice and resources.

The platform may be a full stack web application in which the backend may facilitate authentication and session management, and interaction information produced by the interaction builder 312, as described in more detail elsewhere herein. As used herein, the term full stack web application means a web application that includes both a frontend (e.g. what a user interacts with) and a backend (e.g., the logic, databases, and servers that power the application). The backend may also communicate with an AI engine microservice that facilitates generation of clarifying questions, resolution matching, and redirections to other self-serve tools within an organization's secure network.

In some embodiments, users are authenticated via access to the organization's firewall and are prompted to input a query into the platform via a web-portal. Typically, this will result in one of two outcomes, namely the identification by the platform of a redirection opportunity to an existing self-service resource or, alternatively, initiation of a call or chat with a live agent.

A self-service resource may include, but is not limited to, automated tools, materials, contact information, and/or other content or information provided by an organization that enable users to resolve issues or find answers to queries on their own, without needing to contact a live agent via chat or telephone. These resources often include FAQs, knowledge bases, tutorials, troubleshooting guides, forums, and chatbots.

If initiation of a call or chat with a live agent is warranted, the platform may prompt the user to contact a call center or may initiate a live chat window via the web-portal, and the user may be added to a queue of users waiting to be served by a live agent (e.g., either automatically when the live chat window is opened, or after the user calls the telephone number provided to them via the web-portal). While the user is waiting in the queue, the platform may begin to generate probing questions to better contextualize the nature of the user query.

Once a certain condition has been met for ending the questions, the web-portal may allow the user to generate and submit an AI-driven summary of the sequence of questions and answers (i.e., their interaction history) into a digital workflow platform, such as an HR service delivery platform. The summarized interaction history may then be provided to the live agent who will eventually handle the call/chat by way of a complete.

Accordingly, the platform liberates time spent on tedious in-call authentication, identifies and redirect enquiries based on their appropriateness for existing self-service resources, transforms queue wait times to become a productive phase of a call by enabling users to populate interactions in HR service delivery platforms (e.g., such as an interaction created in the ServiceNow™ platform), and accelerates eventual diagnosis of an issue by a live agent using the AI-driven summary of the sequence of questions and answers created during the queuing time.

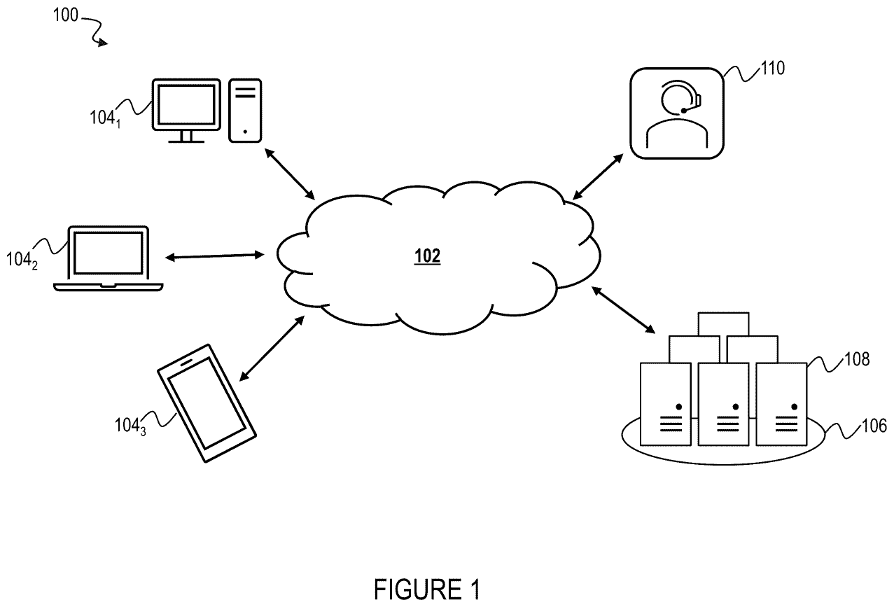

Referring now to FIG. 1, there is shown a computer network 100 that comprises an example embodiment of a system implementing the systems and methods described herein. More particularly, the computer network 100 comprises a wide area network 102 such as the Internet to which various user devices 104ₓ, a call center 110, and data center 106 are communicatively coupled. The data center 106 comprises a number of servers 108 networked together to collectively perform various computing functions. For example, in the context of a financial institution such as a bank, the data center 106 may host online human resource services that permit users (e.g., employees) to log in to those servers using user accounts that give them access to various computer-implemented human resource services and information.

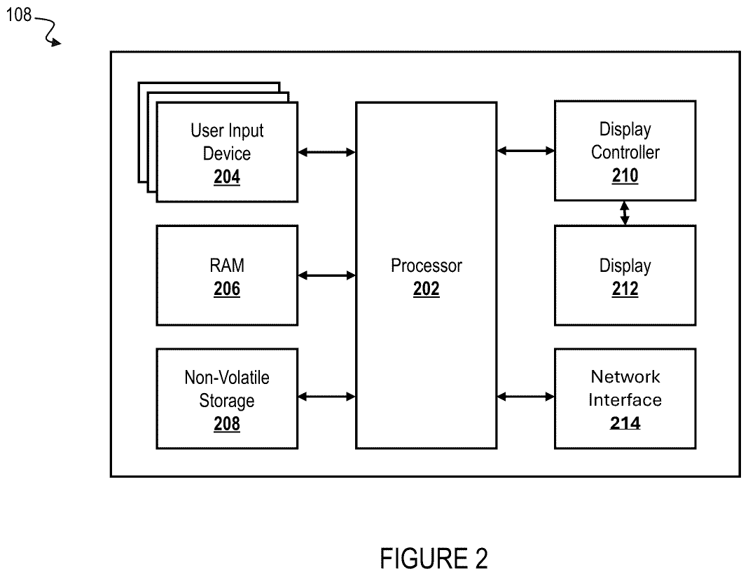

Referring now to FIG. 2, there is depicted an example embodiment of one of the servers 108 that comprises the data center 106. The server comprises a processor 202 that controls the server's 108 overall operation. The processor 202 is communicatively coupled to and controls several subsystems. These subsystems comprise user input devices 204, which may comprise, for example, any one or more of a keyboard, mouse, touch screen, voice control; random access memory (“RAM”) 206, which stores computer program code for execution at runtime by the processor 202; non-volatile storage 208, which stores the computer program code executed by the RAM 206 at runtime; a display controller 210, which is communicatively coupled to and controls a display 212; and a network interface 214, which facilitates network communications with the wide area network 104 and the other servers 108 in the data center 106.

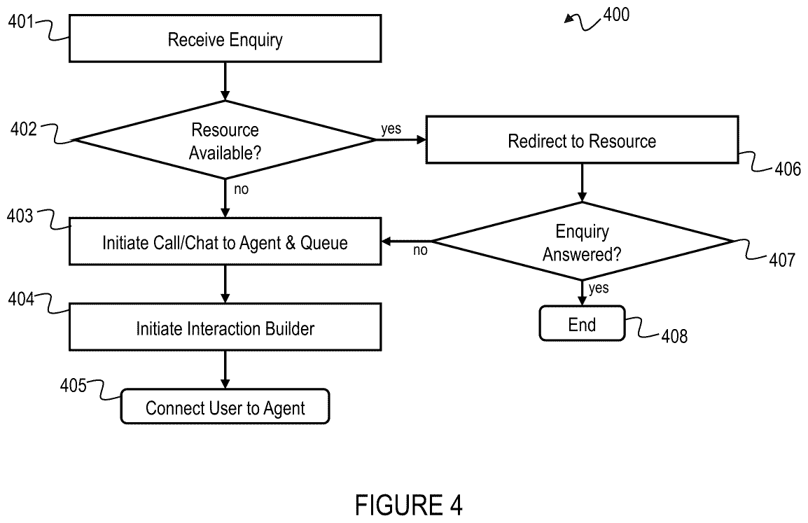

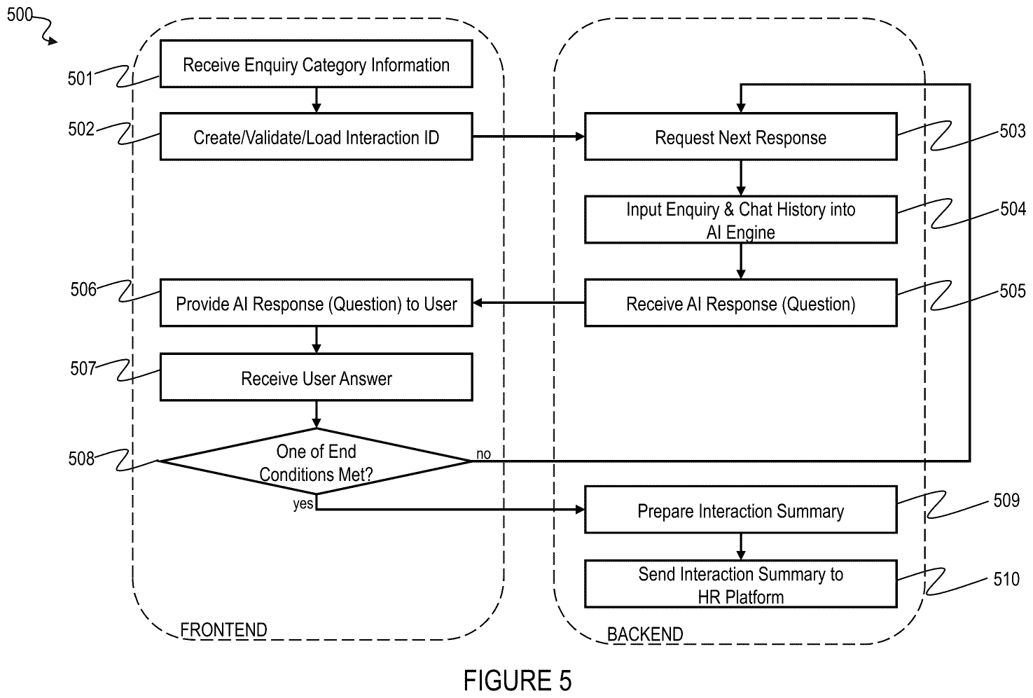

The non-volatile storage 208 has stored on its computer program code that is loaded into the RAM 206 at runtime and that is executable by the processor 202. When the computer program code is executed by the processor 202, the processor 202 causes the server 108 to implement methods such as those shown in of FIG. 4 and FIG. 5, which are described in more detail elsewhere herein. Additionally, or alternatively, the servers 108 may collectively perform that method using distributed computing. While the system depicted in FIG. 2 is described specifically in respect of one of the servers 108, analogous versions of the system may also be used for the user devices 104.

When user device 104ₓ first access the platform running in full or in part on servers 108, they are required to provide the credentials necessary to access a secured network of an organization (such as a corporation or financial institution). In some embodiments, such identification and authentication can be performed by way of third-party cloud or web services, such as Microsoft Azure Cloud Services™, for example. Once logged in, the user can use their device 104ₓ to navigate to a web-portal which may act as the primary interface between the user and the platform.

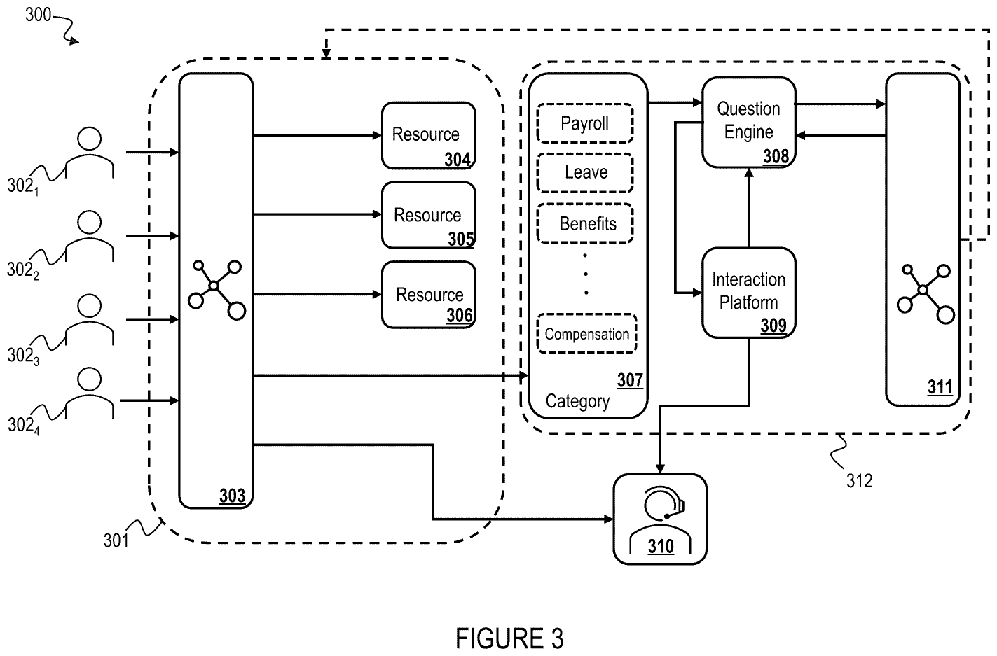

With reference to FIGS. 3 & 4, non-limiting embodiments of the systems and methods for implementing classification and redirection 301 will now be described. A user 302₂ first uses a user device 104₂ to access the platform via a web-portal. At step 401, the user may input a query into the web-portal. For example, the user may input “When do I get my pay?”. The enquiry is sent to an AI engine 303 to determine (at step 402) whether a solution can be found using self-service resources 304, 305, 306.

In some embodiments, AI engine 303 comprises one or more Retrieval Augmented Generation (RAG) models combined with a Large Language Model (LLM). The one or more RAGs allow the Large Language Model (LLM) to be kept up to date with internal information (i.e., information internal to the organization) and only provide information relevant to internal purposes. In some embodiments, the one or more RAGs may also allow the LLM to provide information relevant to specific internal departments (e.g., human resources). In some embodiments, the AI engine 303 may be developed implementing RAG with various optimization techniques through pre-processing, indexing, and prompt engineering for a faster and more accurate responses.

Self-service resources 304, 305, 306 may include automated tools (such as specialized chatbots for answering information technology (IT), human resources (HR), or payroll questions. Self-service resources 304, 305, 306 may additionally or alternatively comprise materials (e.g., web pages, knowledge bases, FAQs, troubleshooting guides), contact information (e.g., telephone numbers or webpages of individuals or departments), and/or other content or information (e.g., forums and tutorials) provided by the organization that enable users to resolve issues or find answers to queries.

If at step 402 a solution is determined with enough confidence, the user 302₂ will be directed to that self-service resource at step 406. In some embodiments, at step 407, the web portal then prompts the user 302₂ to indicate whether their enquiry has been suitably answered by the self-service resource to which the AI engine redirected them. If the self-service resource suitably answered the user's query, the method may come to an end at step 408.

If, however, the self-service resource did not suitably answer the user's query, or no suitable self-service resource was found at step 402, a call or chat is initiated to an agent at step 403.

In some embodiments, a chat may be initiated at step 403 and the web-portal may open a chat window. At that point, the platform will add the chat to a queue and wait for an available live agent. In other embodiments, a telephone call may be initiated at step 403 by providing the user, via the web-portal, with the telephone number of the call center 110. Once the user 302₂ dials the number, they are then added to a call queue.

Then, at step 404, the platform will initiate the interaction builder, as described in more detail elsewhere herein. Once the interaction builder has completed the interaction, the user 302₂ will be connected to a live agent 310 at step 405.

With reference to FIGS. 3 & 5, non-limiting embodiments of the systems and methods for implementing interaction builder 312 will now be described.

In some embodiments, the interaction builder 312 may be initiated by the web portal. In some embodiments, this can be done by way of a “Create Interaction” button presented in the web-portal.

When the user 302₂ indicates, via the web-portal, that they wish to begin an interaction with the platform, the platform initializes an interaction builder session 500 and creates a database entry for the interaction instance in non-volatile storage 208. In some embodiments, this can be done by interaction platform 309. In some embodiments, the user is then prompted to select a category relating to their enquiry, based on existing categories listed in the platform. In the non-limiting example of a human resources service platform disclosed herein, the categories 307 may include, for example, “payroll”, “leave”, “benefits”, “compensation”, etc.

In some embodiments, parts of the database are pre-filled by the interaction platform 309 using existing user data which may have been retrieved as a result of the identification and authentication of the user 302₂, as described in more detail elsewhere herein. At step 501, the interaction platform 309 receives the enquiry category information and saves it to the interaction entry in the database.

In some embodiments, at step 502, the interaction platform 309 creates a unique interaction ID associated with the interaction instance and the newly created interaction entry in the database. The unique interaction ID may then be returned to the web-portal to be used as a URL slug to proceed to the interaction builder 312 (e.g., “/builder/interactionID”).

The system may then validate the interaction ID from the URL slug by querying the database for the matching interaction instance. If not found, the user may be directed to a “/404 not found” page. Otherwise, the interaction builder 312 may populate the web-portal with interaction metadata extracted from the interaction entry in the database associated with the interaction ID. In some embodiments, the user 302₂ may at this point be prompted to dial the telephone number to enter a call queue, if they have not yet done so. Alternatively, or additionally, the user may be prompted at this point to confirm that they have entered the call queue. Once this confirmation is received, the method 500 will proceed to step 503.

At step 503, the frontend may request a question from the backend for the interaction. In some embodiments, the interaction ID may be used as a query parameter. At that point, the backend may validate that the interaction exists again and query any chat history associated with the interaction. The generated question is recorded into the chat history housed in the database, as described in more detail elsewhere herein.

Then, at step 504, the backend may request that question engine 308 generate the next question based on the initial enquiry and any chat history. At step 505, the question engine 308 may then return a response, which may include a question, and/or a potential self-service solution if one is generated. The response may then be recorded in the chat history by the backend and sent to the frontend to be provided to the user via the web-portal at step 506.

Question engine 308 may use AI engine 311 to generate responses. In some embodiments, AI engine 311 comprises one or more Retrieval Augmented Generation (RAG) models combined with a Large Language Model (LLM). The one or more RAGs allow an LLM to be up to date with internal information (i.e., information internal to the organization) and only provide information relevant to internal purposes. In some embodiments, the one or more RAGs may also allow the LLM to provide information relevant to specific internal departments (e.g., human resources). In some embodiments, the AI engine 311 may be developed implementing RAG with various optimization techniques through pre-processing, indexing, and prompt engineering for faster and accurate responses. In some embodiments AI engine 311 may be the same as AI engine 303. In some embodiments, the RAG model may be designed to specialize in question-answer tasks.

The data source for the model may be textual information (e.g., web content) from the organization's internal servers. The pages may be extracted and grouped into question-answer pairs and then processed into JSON format. Such data normalization processes may ensure consistent data retrieval and formatting that optimizes the retrieval content quality. In some embodiments, the normalized JSON data may then be broken down into segments and turned into vector embeddings of size 1536 using, for example, the ADA 002 text-embedding model, to be inserted into the vector database.

In this example, due to the large embedding size, it is possible to parse the entire chat history for retrieval. If the chat history does reach a pre-defined limit, it is possible to implement a queue in which the earliest chat message is pushed out of the context first. The history in the queue may then be summarized for better LLM understanding, and this summary may be included into the prompt used to retrieve a potential solution.

In some embodiments, when a potential solution is retrieved from the vector database, it may be evaluated by an LLM on its potential relevance to the user enquiry. If it is to be used, it is augmented to the query to be used as part of the response generation component. Few-shot prompting may be used to guide LLM responses in an expected manner. The prompt may be composed of the augmented query with chat history and few-shot examples of sample responses. It may then be sent to the LLM to generate the responses.

In some embodiments, the question engine 308 may generate different types of responses associated with different endpoints. For example, the question engine may generate a solution, a clarifying question or a redirection to another source of information or another resource (such as, for example, resources 304, 305, 306). Alternatively, the question engine my generate a summarized version of the chat history in concise point forms that is concise and fast for the agent to understand the user's problem.

In some embodiments, if the question engine generates a solution, the backend will forward a formatted response to the frontend to signal different formatting to present to the user on the frontend (i.e., a solution as opposed to a further question at step 506). The user can choose to accept the proposed solution, thus closing the interaction in the database, or continue with the call and interaction builder, thus continuing with step 507.

When the frontend receives and displays a question (at step 506), the user is prompted to submit an answer, which is received by the system at step 507.

Then, at step 508, a determination is made as to whether an end condition has been met. If no end condition has been met, the user's answer, received at step 507 is sent to the backend and recorded in the chat history by interaction platform 309, end the method starts again at step 503, which will then request a new question from the question engine (step 503) and input the enquiry and updated chat history into the AI engine. The question or proposed solution is then recorded in history and forwarded to the frontend. This cycle is repeated until an end condition is determined to have been met at step 508.

In some embodiments, an end condition may arise when the user is connected with a live agent (i.e., the user emerges from the queue) and notifies the system via the web portal that they are no longer in the queue. In some embodiments, the user can notify the system by clicking on a “Submit Interaction” button, or by typing “I have now been connected to an agent” or “I would like to submit this interaction” in the answer section. In some embodiments, an end condition can arise when the user is satisfied with the number of questions they have answered. In some embodiments, an end condition can arise when the question engine has no more questions to ask and prompts the user to continue and submit their interaction.

When an end condition is determined to have been met at step 508, the front end will request that the interaction builder 312 close the interaction. The question engine can then leverage the summarizing capabilities of AI engine 311 to aggregate the authentication information, interaction metadata, and chat history into one detailed interaction summary at step 509.

The system may then use the information saved to the interaction entry in the database to automatically populate an interaction build (at step 510) in the HR service delivery platform (e.g., such as an interaction created in the ServiceNow™ platform), which build can subsequently be accessed by the live call/chat agent. The system may then return the unique ID of the interaction build, referred to as the Interaction Management Service (IMS) number, which is a recorded in the database for that interaction, and forwards that information to the frontend for display to the user, via the web-portal. This response may signal a successful submission of an interaction from the interaction builder and the interaction builder may then be replaced in the web-portal by a confirmation page outlining details of the generated interaction build and its associated IMS number.

The user may then wait to be connected to a live agent. Once connected, the user may relay the new IMS number they received to the live agent, who can then query the agent-side HR service delivery platform using the IMS number, at which point the user will have been authenticated and the live agent will have access to the interaction build containing the information produced in the interaction summary.

The processor used in the foregoing embodiments may comprise, for example, a processing unit (such as a processor, microprocessor, or programmable logic controller) or a microcontroller (which comprises both a processing unit and a non-transitory computer readable medium). Examples of computer readable media that are non-transitory include disc-based media such as CD-ROMs and DVDs, magnetic media such as hard drives and other forms of magnetic disk storage, semiconductor-based media such as flash media, random access memory (including DRAM and SRAM), and read only memory. As an alternative to an implementation that relies on processor-executed computer program code, a hardware-based implementation may be used. For example, an application-specific integrated circuit (ASIC), field programmable gate array (FPGA), system-on-a-chip (SoC), or other suitable type of hardware implementation may be used as an alternative to or to supplement an implementation that relies primarily on a processor executing computer program code stored on a computer medium.

The embodiments have been described above with reference to flow, sequence, and block diagrams of methods, apparatuses, systems, and computer program products. In this regard, the depicted flow, sequence, and block diagrams illustrate the architecture, functionality, and operation of implementations of various embodiments. For instance, each block of the flow and block diagrams and operation in the sequence diagrams may represent a module, segment, or portion of code, which comprises one or more executable instructions for implementing the specified action(s). In some alternative embodiments, the action(s) noted in that block or operation may occur out of the order noted in those figures.

For example, two blocks or operations shown in succession may, in some embodiments, be executed substantially concurrently, or the blocks or operations may sometimes be executed in the reverse order, depending upon the functionality involved. Some specific examples of the foregoing have been noted above but those noted examples are not necessarily the only examples. Each block of the flow and block diagrams and operation of the sequence diagrams, and combinations of those blocks and operations, may be implemented by special purpose hardware-based systems that perform the specified functions or acts, or combinations of special purpose hardware and computer instructions.

The terminology used herein is for the purpose of describing particular embodiments only and is not intended to be limiting. Accordingly, as used herein, the singular forms “a”, “an”, and “the” are intended to include the plural forms as well, unless the context clearly indicates otherwise (e.g., a reference in the claims to “a challenge” or “the challenge” does not exclude embodiments in which multiple challenges are used). It will be further understood that the terms “comprises” and “comprising”, when used in this specification, specify the presence of one or more stated features, integers, steps, operations, elements, and components, but do not preclude the presence or addition of one or more other features, integers, steps, operations, elements, components, and groups. Directional terms such as “top”, “bottom”, “upwards”, “downwards”, “vertically”, and “laterally” are used in the following description for the purpose of providing relative reference only, and are not intended to suggest any limitations on how any article is to be positioned during use, or to be mounted in an assembly or relative to an environment. Additionally, the term “connect” and variants of it such as “connected”, “connects”, and “connecting” as used in this description are intended to include indirect and direct connections unless otherwise indicated. For example, if a first device is connected to a second device, that coupling may be through a direct connection or through an indirect connection via other devices and connections. Similarly, if the first device is communicatively connected to the second device, communication may be through a direct connection or through an indirect connection via other devices and connections. The term “and/or” as used herein in conjunction with a list means any one or more items from that list. For example, “A, B, and/or C” means “any one or more of A, B, and C”.

It is contemplated that any part of any aspect or embodiment discussed in this specification can be implemented or combined with any part of any other aspect or embodiment discussed in this specification.

The scope of the claims should not be limited by the embodiments set forth in the above examples but should be given the broadest interpretation consistent with the description as a whole.

It should be recognized that features and aspects of the various examples provided above can be combined into further examples that also fall within the scope of the present disclosure. In addition, the figures are not to scale and may have size and shape exaggerated for illustrative purposes.

As will be understood from the present description, the integration of LLMs and RAGs with help center portals as described herein represent significantly more than merely using categories to organize, store and transmit information and organizing information through mathematical correlations. The integration of LLMs and RAGs with call center portals is in fact an improvement to the technology of machine learning, as this integration provides for the initialization of call center portals without the need for real user data, which may improve initial performance of a call center portal as compared to a cold start without initialization. It not only lowers the costs associated with data collection but also mitigates privacy concerns, as it does not involve real user data. The integration of LLMs and RAGs with call center portals as described herein provides a cost-effective and privacy-preserving solution for training models in personalized systems. Moreover, the technology is confined to machine learning applications.

While the applicant's teachings described herein are in conjunction with various embodiments for illustrative purposes, it is not intended that the applicant's teachings be limited to such embodiments as the embodiments described herein are intended to be examples. On the contrary, the applicant's teachings described and illustrated herein encompass various alternatives, modifications, and equivalents, without departing from the embodiments described herein, the general scope of which is defined in the appended claims.

1. A method of implementing help center platform interactions comprising:
receiving a user enquiry via a user interaction portal;
providing the user with contact information of a live agent help center and a ticket number associated with the enquiry and an interaction session via the user interaction portal; and
while the user is waiting in a queue to be connected to a live agent, initiating an interaction session by:
prompting a question engine using the enquiry and an interaction history generated during the session, the output of the question engine being at least one question related to the enquiry;
displaying the at least one question to the user via the user interaction portal;
obtaining at least one answer to the at least one question from the user via the user interaction portal;
adding the at least one question and any associated at least one answer to the interaction history related to the session; and
repeating the above steps of prompting a question engine, displaying at least one question, obtaining at least one answer and adding the at least one question and at least one answer to the interaction history until detection of an end trigger event.

2. The method of claim 1, further comprising:
determining whether the enquiry can be attributed to a self-service resource and, if the enquiry can be attributed to a self-service resource, providing the user with access to the self-service resource via the user interaction portal and, if the enquiry cannot be attributed to a self-service resource, proceeding to initiating an interaction session.

3. The method of claim 2, wherein the self-service resource is one or more of a specialized chatbot, web pages, knowledge bases, FAQs, troubleshooting guides, telephone numbers or webpages of individuals or departments, and/or forums and tutorials.

4. The method of claim 2, wherein determining whether the enquiry can be attributed to a self-service resource is performed by the question engine.

5. The method of claim 1, wherein the method further comprises:
if the end trigger event is detected, summarizing the enquiry and the interaction history generated during the session to produce an interaction summary including the ticket number.

6. The method of claim 5, wherein the interaction summary is used to populate an interaction build in a service delivery platform.

7. The method of claim 5, wherein the interaction summary and/or the interaction build is forwarded to a live agent assigned to the ticket number.

8. The method of claim 1, wherein the step of initiating an interaction session further comprises waiting until the user uses the contact information to contact the live agent help center before prompting the question engine.

9. The method of claim 7, wherein the contact information corresponds to a telephone number associated with the live agent help center and the live agent help center is a telephone call center.

10. The method of claim 7, wherein the contact information corresponds to a chat button associated with the live agent help center and the live agent help center is a chat center.

11. The method of claim 8, wherein the telephone number is also associated with the ticket number.

12. The method of claim 1, wherein the user interaction portal is a web-portal requiring user authentication.

13. The method of claim 1, wherein the question engine is implemented using a Large Language Model.

14. The method of claim 1, wherein the question engine is implemented using Retrieval-Augmented Generation.

15. A non-transitory computer program product comprising computer-implemented instructions to cause a computer system to execute the method of claim 1.

16. A computer system comprising:
one or more computer processors; and
one or more computer readable storage media for storing computer-implemented instructions, wherein the one or more computer processors are configured to execute the computer-implemented instructions to cause the computer system to implement the method of claim 1.
